(19) United States
(12) Patent Application Publication
(10) Pub. No.: US 2004/0075789 A1
(43) Pub. Date: Apr. 22, 2004

(54) Integrated color filter and method of its fabrication

(75) Inventor: Yu-Fang Wang, Taoyuan Hsien (TW)

Correspondence Address: FOLEY & LARDNER, 2029 CENTURY PARK EAST, SUITE 3500, LOS ANGELES, CA, 90067

(73) Assignee: HannStar Display Corp.

(21) Appl. No.: 10/661,758

(22) Filed: Sep. 12, 2003

(30) Foreign Application Priority Data
Oct. 21, 2002 (TW) 091124256

(51) Int. Cl. G02F 1/1335

(52) U.S. Cl. 349/106

(57) ABSTRACT

A protruding pattern is formed by photolithography on the gate and signal lines of an active matrix. The protruding pattern defines color filter unit areas for each pixel of the active matrix. Resins of appropriate colors are then introduced to each of the color filter unit areas by an ink-jet printer. The protruding pattern retains the printed resins within the photolithographically defined areas, thus providing a highly accurate color filter unit structures while eliminating the complexity and waste of conventional colored resin patterning techniques. The protruding pattern is preferably also formed over the transistor of each pixel area and provided with a contact hole that exposes a portion of the drain electrode of each transistor. This allows pixel electrode material formed over the color filter units to be formed directly in contact with the drain electrodes of the transistors, thus providing electrical connection of the pixel electrodes to their corresponding transistors during the electrode deposition process.

### RELATED APPLICATIONS

This application claims priority under 35 USC 119 from Taiwanese Patent Application 091124256, filed 21 Oct. 2002, the entirety of which is incorporated herein by reference.

### BACKGROUND OF THE INVENTION

1. Field of the Invention

The present invention relates to color filters for liquid crystal displays, and more particularly to integrated color filters.

2. Description of the Related Art

FIG. 1 is a cross-section showing a conventional LCD. A liquid crystal layer 1 is placed between opposing glass substrates 30, 30′. In the manufacturing process, an active matrix 20 including switching elements 22 for respective pixels of the array is formed on the glass substrates 30, pixel electrodes 32 controlled by the switching elements 22, and a color filter layer having red (R) 33, green (G) 34 and blue (B) 35 filter units is formed on the other glass substrate 30′. The two substrates are then aligned and joined to have a gap between them, into which liquid crystal is introduced to form the liquid crystal layer 1. During manufacturing, precise alignment must be achieved, and a specific gap must be preserved, otherwise yield is compromised.

To avoid these strict quality requirements, techniques for forming integrated color filters (ICF) have been developed. ICF techniques form a color filter, a black matrix and an active matrix all on the same substrate, thus avoiding the requirements for strict alignment of opposing substrates. Examples of ICF techniques include a color filter on array (COA) process and an array on color filter (AOC) process.

FIG. 2 is a cross-section showing a COA-type LCD. An active matrix 20 of thin film transistor switching elements 23 is formed on a glass substrate 10. A color filter with red (R) 33, green (G) 34 and blue (B) 35 filter units is then formed directly on the active matrix substrate. By integration of the color filter and active matrix manufacturing processes, light leakage resulting from misalignment is avoided, and aperture ratio and brightness are increased.

In the conventional COA manufacturing process, the red (R) 33, green (G) 34 and blue (B) 35 filter units are formed by spin-coating or slit-coating, whereby red, green and blue-colored resins are respectively coated on the active matrix substrate and patterned by photolithography to define individual filter units. Thus spin-coating (or slit-coating) and photolithography must be performed three times to form the three types of filter units, which complicates the manufacturing process and wastes colored resins during spin-coating (or slit-coating), thus increasing cost.

For the above reasons, it is critical to reduce the waste of colored resins and to simplify the COA manufacturing process to achieve production that is more efficient.

Currently, numerous methods have been developed to fabricate color filters, including pigment dispersion, dyeing, electrodeposition, and printing. Among the above methods, pigment dispersion methods such as spin coating and slit coating are the most popular. However, due to disadvantages such as waste of color resins and higher cost of equipment for mass production, electrodeposition and printing methods have been proposed. Printing costs less, and early disadvantages of printing such as low definition and poor reproduction have been overcome by recent advances in ink-jet printing technology.

Ink-jet printing is a digitally driven method that is highly automatic and does not require a photomask. The cost of manufacturing for ink-jet printing is hence reduced through elimination of photolithography steps and effective utilization of raw materials such as colored resins. In addition, ink-jet printing requires relatively little solution, which reduces waste while lowering the risk of environmental pollution. Therefore, ink-jet printing is a promising method for material distribution to supersede conventional lithography.

### SUMMARY OF THE INVENTION

Embodiments of the invention provide an integrated color filter having color filter units that have the structural precision of color filter units formed by photolithographic techniques without patterning the color filter units themselves photolithographically.

In accordance with a preferred embodiment of the invention, a protruding pattern is formed by photolithography on the gate and signal lines of an active matrix. The protruding pattern defines color filter unit areas for each pixel of the active matrix. Resins of appropriate colors are then introduced to each of the color filter unit areas by an ink-jet printer. The protruding pattern retains the ink-jet printed resins within the respective photolithographically defined areas, thus providing color filter unit structures having photolithographic accuracy while eliminating the complexity and waste of conventional colored resin patterning techniques. The protruding pattern is preferably also formed over the transistor of each pixel area and provided with a contact hole that exposes a portion of the drain electrode of each transistor. This allows pixel electrode material formed over the color filter units to be formed directly in contact with the drain electrodes of the transistors, thus providing electrical connection of the pixel electrodes to their corresponding transistors during the electrode deposition process.

A detailed description is given in the following embodiments with reference to the accompanying drawings.

### DESCRIPTION OF THE DRAWINGS

The present invention can be more fully understood by reading the subsequent detailed description and examples with references made to the accompanying drawings, wherein:

FIG. 1 is a cross-section showing a conventional LCD;

FIG. 2 is a cross-section showing an LCD made by a COA technique;

FIGS. 3a-3d show structure formed during manufacture of a color filter in accordance with a preferred embodiment;

FIG. 4 is a cross-section taken at the line X-X′ in FIG. 3d; and

FIG. 5 shows a schematic representation of an ink-jet printing head.

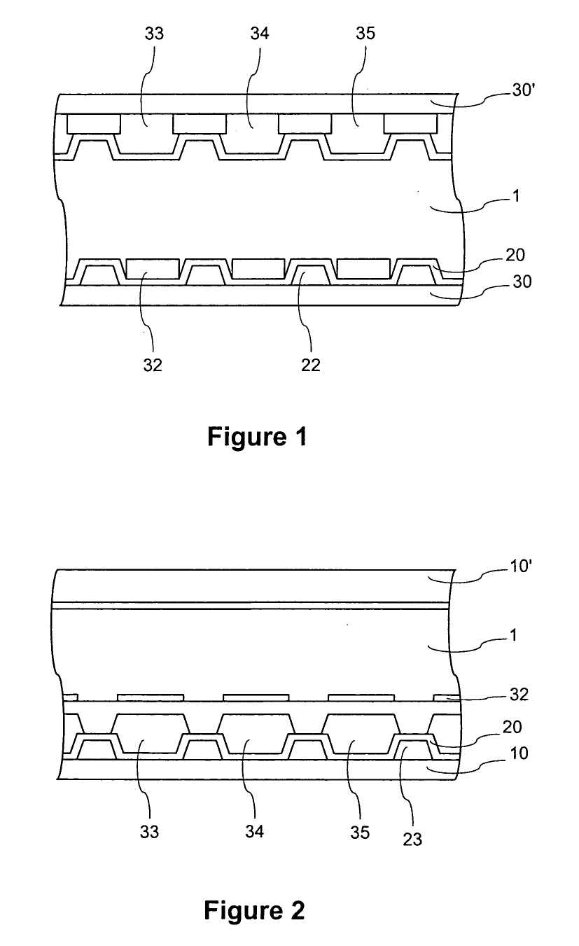

### DETAILED DESCRIPTION OF THE INVENTION

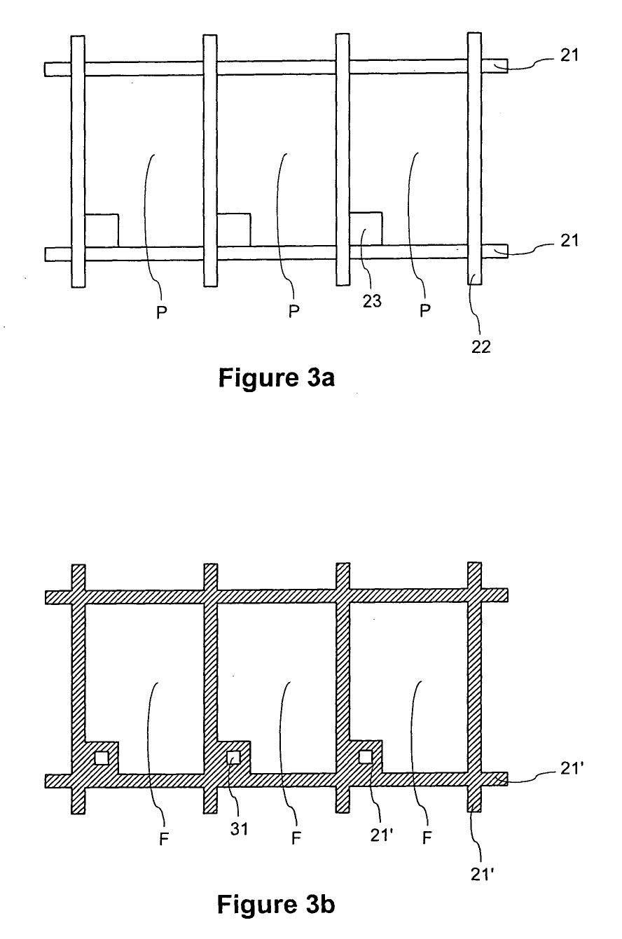

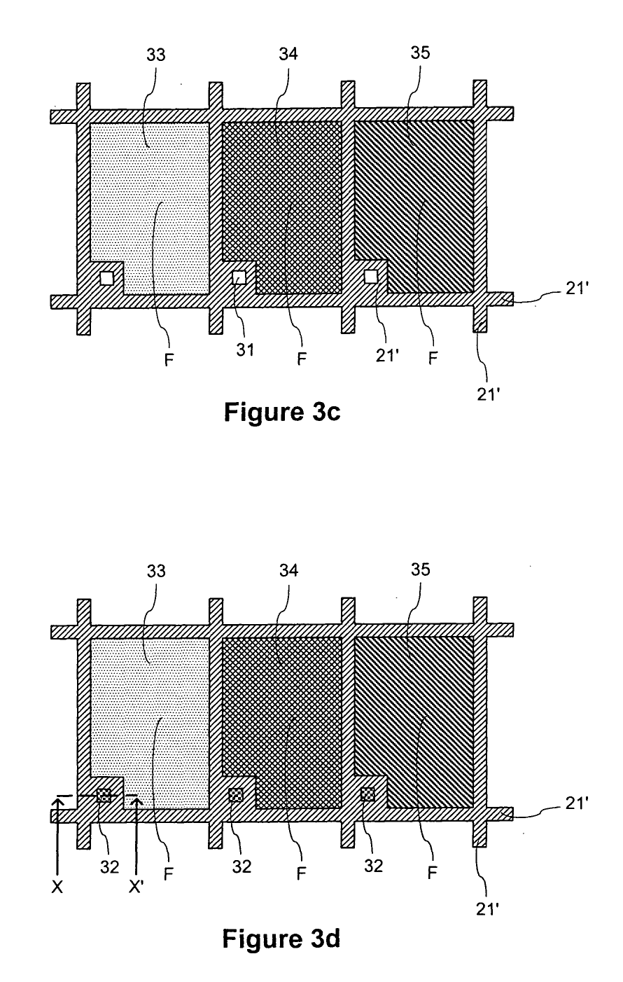

FIGS. 3a-3d show structures formed during manufacture of a color filter in accordance with the preferred embodiment.

The structure of FIG. 3a includes a plurality of substantially parallel gate lines 21, a plurality of substantially parallel signal lines 22, and a plurality of switching elements 23, such as thin film transistors, formed on a substrate. The gate lines 21 and signal lines 22 are essentially perpendicular to each other and define a plurality of pixel areas P.

FIG. 3b shows the structure of FIG. 3a after formation of a protruding pattern 21′ on the gate lines 21 and signal lines 22. To form the protruding pattern a photoresist layer (not shown) is spin-coated on the substrate 10. The photoresist may be a substantially transparent composite (e.g. a composite of acrylic and polycarbonate), a composite with poor transparency (e.g. a composite of polyimide, carbon black and novolak resin), or an opaque composite. In the preferred embodiment, an organic material with poor transparency such as carbon black is employed. The photoresist layer is then patterned by photolithography through exposure and development to leave a protruding pattern 21′ that is formed on the gate lines 21, the signal lines 22 and the switching elements 23. The protruding pattern 21′ serves to partition the substrate into respective color filter areas F. The protruding pattern 21′ includes contact holes 31 that expose portions of the switching elements 23 such that pixel electrodes can later be deposited in electrical contact with the drain electrodes (not shown) of the switching elements 23.

Ink-jet printing is then used to place resin of appropriate colors in the color filter unit areas defined by the protruding pattern 21. FIG. 5 provides a schematic view in which nozzles 50 of an ink-jet printing head deposit droplets of red resin 33, green resin 34 and blue resin 35 in respective corresponding pixel unit areas defined by the protruding pattern 21′, thus forming a color filter layer having red 33, green 34, and blue 35 filter units.

FIG. 3c shows the structure of FIG. 3b after application of colored resins by ink-jet printing. The protruding pattern 21′ retains the colored resins within the respective color filter unit areas, thus providing photolithographically defined color filter unit structures that do not require individual patterning of each color as in the conventional method.

FIG. 3d shows the structure of FIG. 3c after formation of substantially transparent conductive pixel electrodes 32. The pixel electrodes 32 may be formed, for example, by sputtering of a transparent conductor such as indium tin oxide over the substrate followed by patterning of the indium tin oxide. During formation of the conductive layer, conductive material is deposited in the contact holes formed in the protruding pattern 21′, thus providing electrical contact between the switching elements of the active matrix and corresponding pixel electrodes at the same time that the pixel electrode material is deposited.

The resulting integrated color filter structure shown in FIG. 3d comprises a substrate 10 (bottom, not shown) on which is formed a pixel matrix defined by a plurality of gate lines 21 and signal lines 22, wherein a plurality of pixel areas are enclosed by the matrix of gate lines 21 and signal lines 22. A TFT switching element 23 is formed in each pixel area and is connected to a corresponding signal line 22 and gate line 21. A protruding pattern 21′ is formed on the gate lines 21, the signal lines 22 and the switching elements 23 to define respective color filter areas, and has contact holes 31 that expose a part of each switching element 23. A color filter layer is made up of red 33, green 34 and blue 35 color filter units that are formed on the pixel areas and contained within the color filter unit areas. Pixel electrodes 32 made of a transparent conductor such as indium tin oxide are formed on the respective color filter units and the protruding pattern 21′, with adjacent pixel electrodes having a predetermined spacing between them.

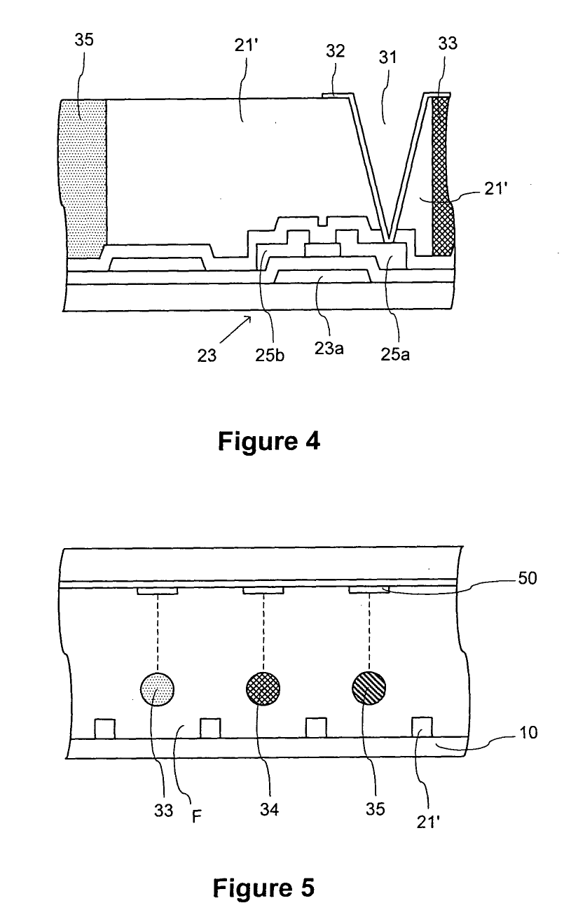

FIG. 4 shows a cross-section taken along line X-X′ of the structure of FIG. 3d. As seen in FIG. 4 and FIG. 3d, the integrated color filter of the preferred embodiment comprises a substrate 10 of, for example, glass, a plurality of gate lines 21 (as shown in FIG. 3a) and gate electrodes 23a extending therefrom formed on the substrate 10, a gate insulating layer 24 formed on the gate electrodes 23a, source electrodes 25a and drain electrodes 25b formed on the gate insulating layer 24 above the gate electrodes 23a to form thin film transistors 23, and a plurality of signal lines 22 formed on a predetermined area of the gate insulating layer 24 to enclose a plurality of pixel areas P together with the gate lines 21 (as shown in FIG. 3a).

The structure of FIG. 3d and FIG. 4 is preferred in that the protruding pattern 21′ formed on the gate line (not shown), signal line 22 and transistor 23 retains the resin applied to the substrate by ink-jet printing within individual color filter unit areas defined for each pixel. The pattern of the protruding pattern 21′ is defined by photolithography and is therefore precisely patterned and accurately registered to the underlying structures. Accordingly, resin applied by ink-jet printing is constrained to a precisely patterned area, and is therefore effectively patterned with the accuracy of photolithography without the need to perform photolithographic processing on the resin itself, or to do so individually for each color. Further, the protruding pattern 21′ has a contact hole 31 that exposes part of the surface of the drain electrode 25a, thus allowing pixel electrodes to be formed in contact with the drain electrode during deposition of the pixel electrode material.

The foregoing description has been presented for purposes of illustration and description. Obvious modifications or variations are possible in light of the above teaching. The embodiments were chosen and described to provide the best illustration of the principles of this invention and its practical application to thereby enable those skilled in the art to utilize the invention in various embodiments and with various modifications as are suited to the particular use contemplated. All such modifications and variations are within the scope of the present invention as determined by the appended claims when interpreted in accordance with the breadth to which they are fairly, legally, and equitably entitled.

What is claimed is:

1. A method of fabricating an integrated color filter for a liquid crystal display (LCD), comprising:
providing a substrate;
forming respective gate lines and signal lines on the substrate, wherein the plurality of gate lines and signal lines define respective pixel areas;
forming a plurality of switching elements electrically connected to the signal lines and gate lines for the pixel areas;
forming a protruding pattern on the gate lines, the signal lines and the switching elements to define respective color filter unit areas;
applying colored resin to form respective color filter units in the color filter unit areas defined by the protruding portion; and
forming respective pixel electrodes on the respective color filter units.

2. The method as claimed in claim 1, wherein the substrate is an insulator.

3. The method as claimed in claim 1, wherein the switching elements are thin film transistors.

4. The method as claimed in claim 1, wherein the protruding pattern is made of organic material.

5. The method as claimed in claim 1, wherein the protruding pattern is a composite of polyimide, carbon black and novolak resin.

6. The method claimed in claim 1, wherein the protruding pattern comprises respective contact holes exposing parts of corresponding switching elements.

7. The method as claimed in claim 6, wherein the pixel electrodes electrically connect to corresponding switching element via the contact holes.

8. The method as claimed in claim 1, wherein the protruding pattern is patterned by photolithography.

9. The method as claimed in claim 1, wherein the gate lines and signal lines are substantially made of opaque conductive materials.

10. The method as claimed in claim 1, wherein the pixel electrodes are substantially made of transparent conductive materials.

11. The method as claimed in claim 1, wherein the colored resin is applied by ink-jet printing.

12. An integrated color filter for a liquid crystal display (LCD), comprising:
a substrate;
a pixel matrix comprised of a plurality of gate lines and signal lines formed on the substrate, wherein the gate lines and signal lines define respective pixel areas;
respective switching elements for each of the pixel areas electrically connected to the signal lines and gate lines;
a protruding pattern formed on the gate lines, the signal lines and the switching elements and defining respective color filter unit areas;
respective color filter units formed in said respective color filter unit areas; and
respective pixel electrodes formed on the respective color filter units.

13. The integrated color filter as claimed in claim 12, wherein the substrate is an insulator.

14. The integrated color filter as claimed in claim 12, wherein the switching elements are thin film transistors.

15. The integrated color filter as claimed in claim 12, wherein the protruding pattern is made of organic material.

16. The integrated color filter as claimed in claim 12, wherein the protruding pattern is a composite of polyimide, carbon black and novolak resin.

17. The integrated color filter as claimed in claim 12, wherein the protruding pattern comprises respective contact holes exposing parts of corresponding switching elements.

18. The integrated color filter as claimed in claim 17, wherein the pixel electrodes electrically connect to corresponding switching elements via the contact holes.

19. The integrated color filter as claimed in claim 12, wherein the protruding pattern is comprised of a photoresist material.

20. The integrated color filter as claimed in claim 12, wherein the gate lines and signal lines are substantially made of opaque conductive materials.

21. The integrated color filter as claimed in claim 12, wherein the pixel electrodes are substantially made of transparent conductive materials.

22. The integrated color filter as claimed in claim 12, wherein the color filter units are formed by ink-jet printing.

23. The integrated color filter as claimed in claim 12, wherein each of said switching elements further comprising:
a gate electrode extending from a gate line;
a gate insulating layer formed on the gate electrodes; and
a pair of source and drain electrodes formed on the gate insulating layer above the gate electrode to form a thin film transistor.
